(19) United States
(12) Patent Application Publication
(10) Pub. No.: US 2012/0058723 A1
(43) Pub. Date: Mar. 8, 2012

(54) GUIDING MODULE AND METHOD OF USING THE SAME

(75) Inventors: Sheng-shan Chen, Tu Cheng (TW); Ying-chieh Yu, Tu Cheng (TW)

(73) Assignee: Cheng Uei Precision Industry Co., LTD., Tu Cheng City (TW)

(21) Appl. No.: 12/876,111

(22) Filed: Sep. 4, 2010

(51) Int. Cl. H04W 88/02; H04B 7/00

(52) U.S. Cl. 455/41.2; 455/556.2

(57) ABSTRACT

Disclosed is a guiding module and method of using the same. The guiding module includes an access unit, a memory unit, a controller and a projection unit. The access unit is used for receiving the guiding information which stores in an electronic product with guiding function. The memory unit is used for storing the guiding information which is sent by the electronic product. The controller is used for processing the guiding information and sending it. The projection unit is used for receiving the guiding information which is sent out by the controller and projecting it. The guiding module utilizes the projection unit for projecting the guiding information of the electronic product so as to magnify the projection picture, therefore, the driver can clearly identify the guiding information.

### BACKGROUND OF THE INVENTION

1. Field of the Invention

The present invention generally relates to a guiding module and method of using the same, and more particularly to an guiding module utilizing the projection unit to project the guiding information of the electronic product so as to magnify the projection picture.

2. Description of Prior Art

With the development of technology, many electronic products, such as cellular phones and PDAs (Personal Digital Assistant) may be loaded with guiding function. Such kinds of electronic products are small, portable and navigation functioned so that plenty of vehicle drivers love to use.

However, the screens of the electronic products, such as the cellular phones, the PDAs and the navigators as aforementioned are too small. Therefore, it is difficult for the vehicle drivers to identify the guiding information on the screens with a glance.

### SUMMARY OF THE INVENTION

For solving the drawbacks of aforementioned prior art, an objective of the present invention is to provide a guiding module to magnify the projection picture for the driver to clearly identify the guiding information of the electronic product with guiding function.

For realizing the aforesaid objective, the guiding module of the present invention comprises an access unit, a memory unit, a controller and a projection unit. The access unit is used for receiving the guiding information which stores in an electronic product with guiding function. The memory unit is used for storing the guiding information which is sent by the electronic product. The controller is used for processing the guiding information and sending it. The projection unit is used for receiving the guiding information which is sent out by the controller and projecting it. The guiding module utilizes the projection unit for projecting the guiding information of the electronic product.

As aforementioned, the guiding module of the present invention can magnify the projection picture of the electronic product with guiding function through the projection unit. Therefore, the driver can clearly identify the guiding information

Another objective of the present invention is to provide a guiding method to magnify the projection picture for the driver to clearly identify the guiding information of the electronic product with guiding function for solving the drawbacks of aforementioned prior art. For realizing the aforesaid objective, the guiding method of the present invention comprises steps of:

(1) receiving guiding information storing in an electronic product with guiding function by the access unit;

(2) storing the guiding information sent by the electronic product with guiding function by the memory unit;

(3) processing the guiding information and sending out the guiding information by the controller; and

(4) receiving the guiding information sent out by the controller and projecting the guiding information by the projection unit.

As aforementioned, the guiding method of the present invention can magnify the projection picture of the electronic product with guiding function through the projection unit for the driver to clearly identify the guiding information of the electronic product with guiding function.

### BRIEF DESCRIPTION OF THE DRAWINGS

FIG. 1 depicts a diagram of a guiding module of the present invention connected with an electronic product with guiding function.

FIG. 2 depicts a flowchart of a method of using the guiding module of the present invention.

### DETAILED DESCRIPTION OF THE INVENTION

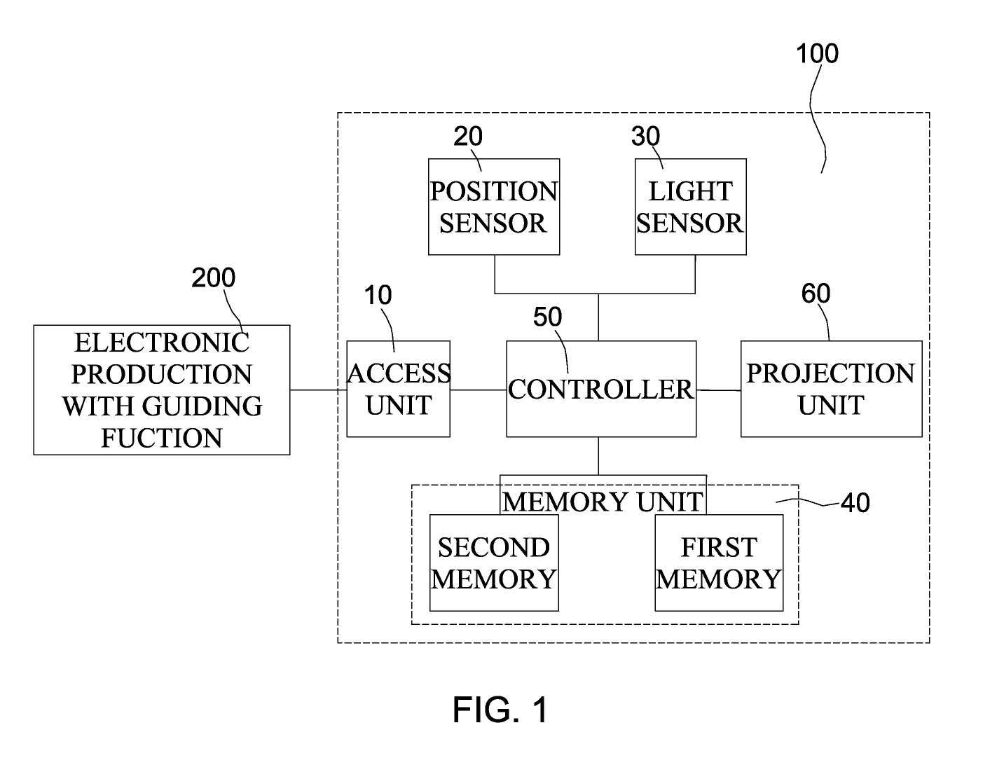

Please refer to FIG. 1, which depicts a diagram of a guiding module 100 of the present invention. The guiding module 100 of the present invention comprises an access unit 10, a position sensor 20, a light sensor 30, a memory unit 40, a controller 50 and a projection unit 60. The guiding module 100 of the present invention is connected with an electronic product with guiding function 200. The access unit 10 is used for receiving and transmitting guiding information of the electronic product with guiding function 200 into the guiding module 100. The access unit 10 can be a connector assembly or a Bluetooth assembly. The connector assembly is used for connecting with the electronic product with guiding function 200 to obtain the guiding information through the controller 50 for storing the guiding information into the memory unit 40. Alternatively, in other embodiments, respective Bluetooth assemblies set in the electronic product with guiding function 200 and the guiding module 100 also can be illustrated to achieve the aforesaid requirement of transmitting the guiding information of the electronic product with guiding function 200 to the guiding module 100.

Please still refer to FIG. 1. The light sensor 30 is used for sensing light intensity in the cabinet and transmits data of the light intensity to the controller 50 immediately. The controller 50 receives the data of the light intensity and adapts a projecting light intensity of the projection unit 60 instantly for meeting the instant change of the light intensity in the cabinet. With the setup of the light sensor 30, the adaptation of the light intensity in the cabinet in real time, the influence to the visibility by the instant change of the light intensity in the cabinet can be prevented. In the daylight, the light intensity is stronger then that in the night. The controller 50 receives the data of the light intensity from the light sensor 30 and controls the projection unit 60 to project the projection picture with stronger projecting light intensity than that in the night to allow the driver indentify the guiding information projected on the windshield properly. On the contrary, a projection picture with weaker projecting light intensity is projected by the projection unit 60 in the night.

The position sensor 20 is used for collecting position information of the guiding module 100 and transmits the position information to the controller 50. The controller 50 adapts and sends out the guiding information according to the position information. The position sensor 20 is setup inside the guiding module 100. The position sensor 20 can be a ball switch or an accelerometer.

The memory unit 40 is used for storing the guiding information sent by the electronic product with guiding function 200. The memory unit 40 further comprises a first memory and a second memory. The first memory stores the guiding information unadapted guiding information sent by the electronic product with guiding function 200. The second memory stores the guiding information adapted by the controller 50. Accordingly, the controller 50 sends out an erect projection picture and the projection unit 60 projects the erect projection picture (in some case, a rotated projection picture information) for always. The projection unit 60 is controlled by the controller 50 to project the guiding information on the windshield of the vehicle.

When the guiding module 100 is used with the electronic product with guiding function 200 for guiding projection, the guiding information showed on the screen of the electronic product with guiding function 200 can be stored in the memory unit 40 of the guiding module 100 by the controller 50 through the access unit 10 of the guiding module 100. As the electronic product with guiding function 200 is setup and fixed erectly on the guiding module 100, the controller 50 of the guiding module 100 reads in the position information of the position sensor 20, which is defined as a non-rotated position. The controller 50 accesses the guiding information stored in the first memory and sends out the unadapted guiding information to the projection unit 60. The projection unit 60 projects the projection picture erectly.

As the electronic product with guiding function 200 is setup and fixed horizontally on the guiding module 100, the controller 50 of the guiding module 100 reads in the position information of the position sensor 20, which is defined as a rotated position because the position sensor 20 is changed. In another word, as the setup of the position sensor 20 is changed from being vertical to being horizontal, the controller 50 accesses the guiding information stored in the first memory and adapts the guiding information with the projection picture to be rotated 90 degrees and stores the adapted guiding information in the second memory. Thereafter, the controller 50 accesses the adapted guiding information in the second memory and sends the adapted guiding information out to the projection unit 60. The projection unit 60 still projects the projection picture erectly.

Accordingly, the controller 50 receives the position information from the position sensor 20 and sends out the erect projection picture and the projection unit 60 always projects the erect projection picture of the guiding information according to the position information.

As aforementioned, the guiding module 100 of the present invention can magnify the projection picture of the electronic product with guiding function 200 through the projection unit 60 for the vehicle driver to clearly identify the guiding information.

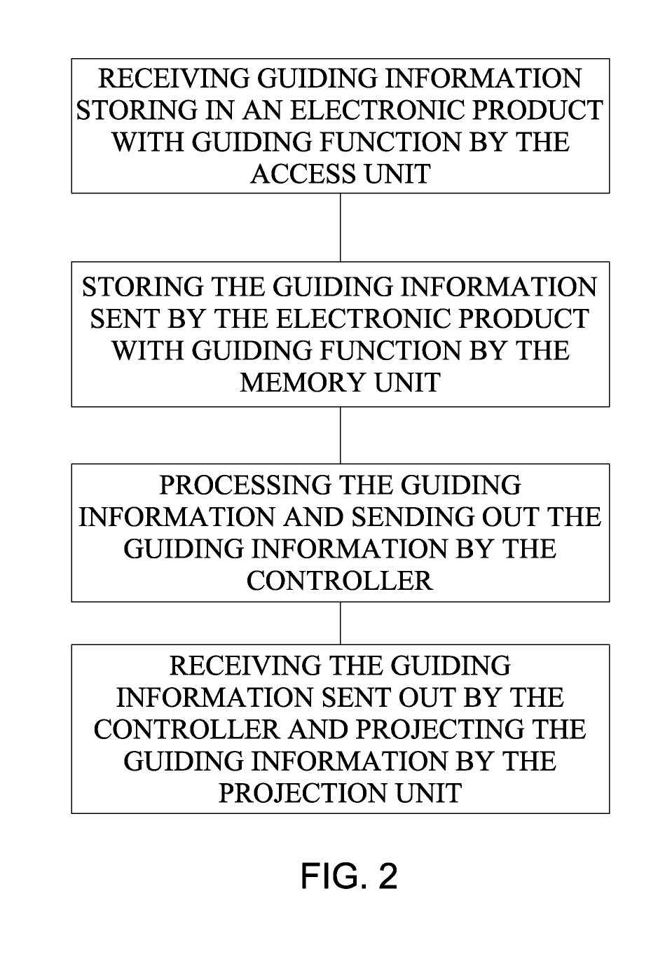

Please refer to FIG. 2, which depicts a flowchart of a method of using the guiding module 100 of the present invention. The method comprises steps of:

(1) receiving guiding information storing in an electronic product with guiding function 200 by the access unit 10;

(2) storing the guiding information sent by the electronic product with guiding function 200 by the memory unit 40;

(3) processing the guiding information and sending out the guiding information by the controller 50; and

(4) receiving the guiding information sent out by the controller 50 and projecting the guiding information by the projection unit 60.

In the aforementioned method, the position sensor 20 is not activated. In the present invention, in case that the ball switch or the accelerometer is in the non-rotated position, the unadapted guiding information stored in the memory unit 40 is directly sent out to the projection unit 60 for the projection by the controller 50.

In case that the position sensor 20, i.e. the ball switch or the accelerometer is changed from the non-rotated position to the rotated position in the present invention, the controller 50 accesses the guiding information stored in the first memory and adapts the guiding information with the projection picture to be rotated 90 degrees and stores the adapted guiding information in the second memory. The controller 50 accesses the adapted guiding information in the second memory and sends the adapted guiding information out to the projection unit 60. Then, the projection unit 60 projects the projection picture.

As aforementioned, the guiding module 100 of the present invention can magnify the projection picture of the electronic product with guiding function 200 through the projection unit 60 for the vehicle driver to clearly identify the guiding information.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A guiding module, comprising:
an access unit, receiving guiding information storing in an electronic product with guiding function;
a memory unit, storing the guiding information sent by the electronic product with guiding function;
a controller, processing the guiding information and sending out the guiding information; and
a projection unit, receiving the guiding information sent out by the controller and projecting the guiding information.

2. The guiding module of claim 1, further comprising a position sensor for collecting the position information of the guiding module and the controller receives the position information and adapts the guiding information according to the position information.

3. The guiding module of claim 2, wherein the position sensor is a ball switch.

4. The guiding module of claim 2, wherein the position sensor is an accelerometer.

5. The guiding module of claim 1, wherein the access unit is a connector assembly.

6. The guiding module of claim 1, wherein the access unit is a Bluetooth assembly.

7. The guiding module of claim 1, further comprising a light sensor for receiving light intensity and transmits data of the light intensity to the controller immediately, wherein the controller adapts a projecting light intensity of the projection unit instantly.

8. The guiding module of claim 1, wherein the memory unit further comprises a first memory and a second memory, wherein the first memory stores the guiding information unadapted guiding information sent by the electronic product with guiding function and the second memory stores the guiding information adapted by the controller.

9. A method of using a guiding module, having an access unit, a memory unit, a controller and a projection unit, the guiding method comprising steps of:
(1) receiving guiding information storing in an electronic product with guiding function by the access unit;
(2) storing the guiding information sent by the electronic product with guiding function by the memory unit;
(3) processing the guiding information and sending out the guiding information by the controller; and
(4) receiving the guiding information sent out by the controller and projecting the guiding information by the projection unit.

10. The method of claim 9, further comprising a step of receiving position information of the guiding module collected and sent out by a position sensor before step (3), wherein the controller sends out rotated projection picture information and the projection unit projects the rotated projection picture information.
